(19) United States
(12) Patent Application Publication
(10) Pub. No.: US 2016/0364681 A1
(43) Pub. Date: Dec. 15, 2016

(54) INVENTORY SYSTEM AND METHOD

(71) Applicant: Andrus Logistics LLC dba Merchmanager, Pleasant Grove, UT (US)

(72) Inventor: Stanley D. Andrus, Pleasant Grove, UT (US)

(73) Assignee: ANDRUS LOGISTICS LLC DBA MERCHMANAGER, Pleasant Grove, UT (US)

(21) Appl. No.: 14/735,828

(22) Filed: Jun. 10, 2015

(51) Int. Cl. G06Q 10/08; G06K 7/10

(52) U.S. Cl. CPC G06Q 10/087; G06K 7/10366

(57) ABSTRACT

An asset management system includes a storage device configured to store an inventory list of a plurality of assets located in more than one location, the assets including physical product. An RFID tag communicating a unique identifier is attached to each asset. The system further includes a system controller that manages the inventory list, and is accessible to a unique user at each location through a web-accessible interface system. The interface system is configured to manage the inventory list and the plurality of assets. The controller defines roles for each unique user of the interface system. Each role grants unique access to information in the inventory list and unique tasks to perform actions on the list and assets. One of the actions includes automatically decrementing an asset from the inventory list upon absence of an RFID tag associated with the asset during an RFID scanning of assets.

### TECHNICAL FIELD

The present disclosure relates to an inventory management system. More particularly, the present disclosure relates to an integrated web-enabled multi-party asset management system for managing mobile inventory and other related assets.

### BACKGROUND

Various parties may be involved in the sales process and supply chain of merchandising product. Such parties may include vendors (including mobile vendors), retailers (with fixed and mobile sales locations), distribution centers, logistic partners (including shippers etc.), and staffing (in consignment sales). Each of these parties (and others) may have unique or overlapping roles as products move from manufacturing to ultimate retail sale. As product moves along the supply chain, differing parties may hold physical possession of product while yet other parties hold the title to said product. Such complex relationships between parties can prove difficult to each party in managing the entire sales process as product moves from location to location.

A successful method of advertising and marketing is to offer goods for sale using a display booth at a particular location, such as a trade show or at large wholesale warehouses, etc. Such locations provide vendors an opportunity to display their goods to hundreds or thousands of potential buyers.

Vendors face real challenges when offering goods for sale at such locations. For example, vendors often lack real-time sales data which has prohibited them from making timely inventory replenishment decisions. Additionally, vendors have poor visibility of actual stock on hand. Also, a roving environment may make it nearly impossible for vendors to inventory product on hand at multiple locations. Such an inability to inventory at a location may require vendors to ship product back to origin to be accounted for, or cause unnecessary product to be shipped on to upcoming shows.

In consignment sales, the relationship between parties is consignor and consignee. The title to property is not transferred to the entity that takes possession of the property until the property crosses the retailer's register, where it is immediately purchased and sold. This entails more risk to a consignor as opposed to selling the property outright in wholesale. Additionally, the consignee does not add the product to inventory and is not concerned with the product until it reaches the register. Retailer's may mandate staffing (provided by the consignor) to ensure that product is stocked, counted, and handled properly. Such staffing (labor costs) are burdensome on vendors as staffing may be required at each individual. In addition, the staffing may be producing manual counts of merchandise which is rife with human errors (intentional or not). Such an arrangement and staffing has been referred to as “rack jobbing.” The staffing that is responsible for maintaining inventory etc. is sometimes referred to as a “rack jobber.”

Additionally, retailers may have many vendors at a single location and may have difficulty in tracking and managing consignment inventory when each vendor employs a different system to track, manage, and update inventory.

Using mobile display booths at large scale retail environments may also increase the chance of product being misplaced, left behind, or misrouted by the retailer's employees. This may directly affect the vendor by costing them money in lost sales due to product being unavailable and/or lost inventory which is unaccounted for. There is thus a need for an improved inventory management system.

### SUMMARY

Embodiments of multi-party asset management system for managing mobile inventory are described. The system includes a storage device configured to store a centralized inventory list of a plurality of assets, the plurality of assets located in more than one storage or retail location. The assets include physical merchandising product. An RFID tag is attached to each of the plurality of assets, and each RFID tag communicates a unique identifier. The system further includes a system controller that manages the inventory list, and the system controller is accessible to a unique user at each of the more than one storage or retail location through a web-accessible interface system. The interface system is configured to manage the centralized inventory list and the plurality of assets. The system controller defines roles for each unique user of the interface system. Each role grants unique access to information in the centralized inventory list and unique tasks to perform actions on the inventory list and the plurality of assets. The roles include a vendor role and a retailer role. One of the actions includes automatically decrementing an asset from the inventory list upon scanning an RFID tag associated with the asset at a point of sale. Other embodiments of an inventory management system are described.

Embodiments of a computer program product are described. The computer program product includes a computer useable storage medium including a computer readable program, and the computer readable program includes instructions that, when executed by a processing device within a computer, cause the computer to perform operations. The operations include storing an inventory list of a plurality of assets, the plurality of assets located in more than one storage or retail location. The assets include merchandising product. An RFID tag is attached to each of the plurality of assets and each RFID tag communicates a unique identifier. The operations further include receiving a signal indicating the scanning of an RFID tag by a user, the RFID tag associated with an asset. The signal is transmitted through a web-accessible interface system coupled to a computing device, the interface system configured to manage the inventory list and the plurality of assets through a system controller. The system controller defines roles for each unique user of the interface system and each role grants unique access to information in the centralized inventory list and unique tasks to perform actions on the inventory list and the plurality of assets. The operations further include decrementing the asset from the inventory list in response to receiving the signal indicating the scanning of the RFID tag.

Embodiments of a computer implemented method for managing mobile inventory are described. The method includes storing an inventory list of a plurality of assets, the plurality of assets located in more than one storage or retail location. The assets include merchandising product. An RFID tag is attached to each of the plurality of assets and each RFID tag communicates a unique identifier. The method further includes receiving a signal indicating the scanning of an RFID tag by a user, the RFID tag associated with an asset at a point of sale. The signal is transmitted through a web-accessible interface system coupled to a computing device, the interface system configured to manage the inventory list and the plurality of assets through a system controller. The system controller defines roles for each unique user of the interface system and each role grants unique access to information in the centralized inventory list and unique tasks to perform actions on the inventory list and the plurality of assets. The method further includes decrementing the asset from the inventory list in response to receiving the signal indicating the scanning of the RFID tag. Other embodiments of the method are also described.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic diagram of one embodiment of a supply chain for product.

FIG. 2 depicts a schematic diagram of one embodiment of an inventory management system.

FIG. 3 depicts a schematic diagram of an embodiment of inventory management system and for allowing unique roles of users granting access to individualized data and action items.

FIG. 4 depicts a schematic diagram of an embodiment of an inventory management system implemented at various locations.

FIGS. 5-9 depict embodiments of a smart phone or computing device with a system interface for implementing and manipulating the modules of the system controller.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity. Similarly, not every embodiment need accomplish all advantages of the present invention.

Throughout the description, similar reference numbers may be used to identify similar elements.

### DETAILED DESCRIPTION

In the following description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

While many embodiments are described herein, at least some of the described embodiments facilitate efficient and real-time monitoring and management of each piece of inventory through the entirety of a supply chain, from manufacture to sale. Some embodiments allow for efficient integration of duties between a vendor, a distribution center, staffing, and a retailer. Real-time information provided through RFID technology allows for vendors to make real-time inventory management decisions without being at each retail site. Some embodiments include a dashboard viewable by many distinct parties that allows for efficient integration of distinct participants along a supply chain. Some embodiments allow for the integration of a distribution center, retailer, and vendor or other parts of a supply chain and to allow for product to be traced and audited.

Consignment sales in a roving environment may present unique challenges to various parties in a supply chain. In consignment sales, the relationship between parties is consignor and consignee. The title to property is not transferred to the entity that takes possession of the property until the property crosses the retailer's register, where it is immediately purchased and sold. This entails more risk to a consignor as opposed to selling the property outright in wholesale. The consignor may wish to take a more active role and require more real time accounting of the consignee and the consignee's possession of the property. An inventory management system allows for the consignor or vendor to access real-time information regarding consignee's inventory and allows both parties to make appropriate decisions based thereon. Some embodiments allow for efficient staffing by providing a “rack jobber” with up to date information to better control and maintain inventory in multiple stores.

Some embodiments allow for a mobile user to utilize a smart phone or similar technology as a point of sale (POS) or point of purchase (POP) and decrement items sold remotely from an integrated inventory list. Some embodiments allow for routing assets from location to location successfully with verification systems to ensure the correct assets reached to the correct location. Such embodiments allow for scans at both the shipping and receiving locations, enabling users to match virtual lists with hard inventory.

Some embodiments allow for a web user to create a temporary remote sales location. Some embodiments allows for remote verification and authentication of various steps in the sales process. Some embodiments allow for an ability of a remote user to push inventory to a remote sales location and perform other related functions concerning the remote sales location. Some embodiments allow for a retailer to seamlessly integrate various vendors. Some embodiments allow for a vendor or other user to create and utilize templates in managing and monitoring inventory levels.

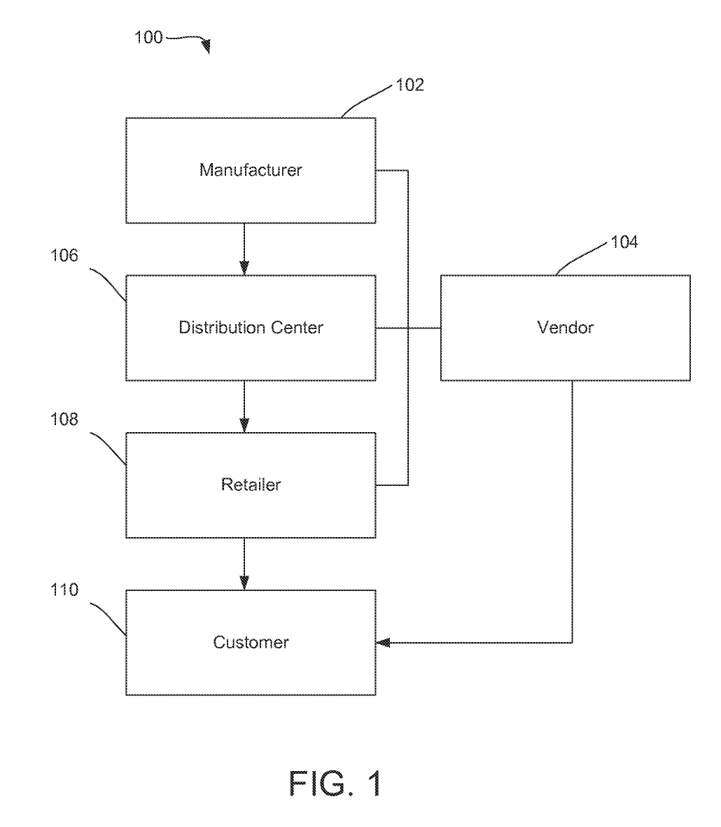

FIG. 1 depicts a schematic diagram of one embodiment of a supply chain 100 for a product. A product may begin at a manufacturer 102, where the product is produced, assembled, or otherwise manufactured. Once manufactured, the product may proceed to market in many different ways. In one example, a vendor 104 may be responsible for managing the supply chain and working to get a product to market. The vendor 104 may commission a manufacturer 102 to manufacture the product. The vendor 104 may utilize a distribution center 106 to store and warehouse product and ship product to a retailer 108 to sell the product at retail. In one example, the distribution center 106 may also ship directly to customers. In another example, a vendor 104 may utilize a consignment sales format to get product to market. Such a consignment sales format may utilize a retailer 108, a wholesale warehouse, a trade show, or other similar venue or location to offer products for sale using a display booth. Such venues provide vendors an opportunity to display their products to many more potential buyers. Product may be sold from vendors 104 directly to customers 110 or through retailers 108 to customers (under consignment or wholesale).

Vendors may also face real challenges when offering product for sale in such a manner. A vendor may lack real-time sales data at retail locations which hinders the vendor's ability to make timely inventory replenishment decisions. Vendors may have poor visibility of actual stock on hand. In a roving environment, determining inventory may be more difficult and inventory may be lost, misrouted, misplaced, or left behind by a retailer's employees. This may directly affect a vendor by costing them money in lost sales due to product unavailability. In addition, without accurate inventory data a vendor may need to ship product back to origin to be accounted for, or cause unneeded product to be shipped on to a future location.

Showrooms allow for vendors to get product out in front of customers. Planning and scheduling shows and events can be difficult as different parties along the supply chain may have difficulty communicating in real time with each other. An inventory management system as described herein allows various partners to update and obtain real-time inventory counts as well as plan and schedule shows and events more efficiently.

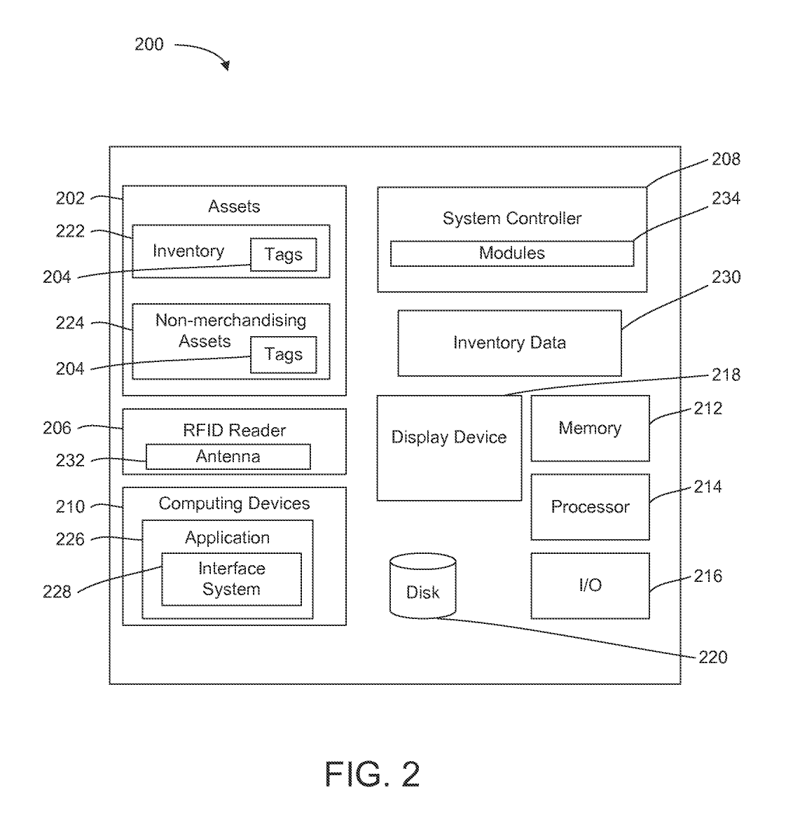

FIG. 2 depicts a schematic diagram of one embodiment of an inventory management system 200. Although the inventory management system 200 is shown and described with certain components and functionality, other embodiments of the inventory management system 200 may include fewer or more components to implement less or more functionality.

The illustrated inventory management includes assets 202 with RFID tags 204, an RFID reader 206, a system controller 208, Computing devices 210, computer memory device 212, processor 214, input/output devices 216, display device 218, and a disk storage device 220. The computer memory device 212 may store data and/or software instructions or computer program instructions for carrying out the operations described herein. The computer memory device 212 may be external or internal to the system and may include but is not limited to a hard drive, a CD/DVD recordable drive, a magnetic tape drive, a disk cartridge drive, a secure digital card, another type of magnetic or optical drive, a solid-state drive, or another type of memory device. The processor 214 is connected to and in communication with the memory device 212 and may store and access data on the memory device 212 for performing the operations described herein. The processor 214 or processing device may also be connected to the disk storage device 220. The disk storage device 220 may be implemented to temporarily store data or software instructions from the memory device 212 or the processor 214. The disk storage device 220 may include but is not limited to a hard disk drive, a floppy disk drive, a removable floppy disk, or other type of optical or magnetic drive.

Assets 202 may include merchandising product or inventory product 222 (product held for ultimate sale) as well as non-merchandising assets 224. Inventory 222 may be any type of physical product. Non-merchandising assets 224 may include assets meant to assist in sale or display of the inventory 222 that is not meant for sale. Examples of non-merchandising assets 224 may include display cases, product holders, or display tables, or other items that might help in the display of inventory 222, etc. In some embodiments, an RFID tag 204 is attached or otherwise affixed to each inventory product 222. In some embodiments, the RFID tags 204 may be affixed to the packaging of inventory product 222. In addition, RFID tags 204 may be affixed to any non-merchandising assets 224 as well. Each RFID tag 204 may provide a unique identifier for each item in inventory allowing for tracking of each item individually. Each RFID tag electronic product code (EPC) allows for uniquely identifying the item to which the RFID tag is affixed. In some embodiments, RFID tags 204 may include a bar code or another optical machine-readable representation of data.

The illustrated embodiment also includes an RFID reader 206 and computing devices 210. The RFID reader 206 may be a standalone RFID scanner connected to a mobile network or may be a smart phone enabled to transmit and receive RFID signals. The RFID reader 206 is connected to (in some cases wirelessly) to at least one computing device 210. Where the RFID reader 206 is a mobile phone, the mobile phone may also be the computing device 210. A computing device 210 and RFID reader 206 may work in tandem to send updated inventory information to update the inventory data 228. In some embodiments, computing devices 210 include an application 226 allowing for communication of information between various parts of the system. The application 226 may be an application on a mobile phone or may be a website. The application 226 grants access to an interface system 228. The interface system 228 allows a user to manage a centralized inventory list or inventory data 230 through the system controller 208. In some embodiments, the RFID reader 206 may also include an antenna 232 that may be used to receive the RFID signals from the RFID tags 204.

Utilizing the RFID tags 204 and the interface system 228, users of the system can access up to date inventory information about all inventory product 222 in their supply chain. This up to date inventory information would include inventory product 222 in any location (including distribution centers, vendor locations, retail locations among various retailers, temporary sales locations, fixed sales locations, and show or display locations, etc.). As RFID data is scanned at any location the information will update the inventory data 230 as the information is communicated through the interface system 228 and the system controller 208. As the inventory data 230 may be accessed through the interface system 228, this permits a user to be able to access inventory data 230 from any device with an internet connection. This allows a vendor who sells product through consignment to instantly know inventory levels at any and all retail locations and make up to date stocking decisions prior to receiving sales data from the retailer. Additionally, as each inventory product is tagged with a unique identifier giving users far greater tractability of individual product. Some traditional inventory tracking systems utilize universal product codes (UPC). UPCs provide a unique identifier for each type of product. With RFIDs individual EPC, users may further serialize each individual item in a type of product. The unique identifier of an EPC allows for greater tracking and for greater accountability of product which allows for the reduction in shrink (lost product or stolen product) as product advances along a supply chain. As product is scanned when shipped, on receipt, or when ultimately sold (sales data), users may have visibility of every step in the supply chain process. Additionally, the system may allow for increased information at a certain location. The system may allow for updates on the location of product within a retail store. That is scanning of product may allow for distinguishing what product is still back in the stock of a particular store and what product has moved to the retail shelves of the particular store.

The system 200 also allows for communication between parties of the system. All communication may go through the interface system 228. Vendors, retailers, distribution centers, and any other users may communicate with each other through the interface system 228. Such communication may occur through various means including a dashboard communication system, notes tagged to certain inventory, shipments, email, or instant messaging, or other communication systems. For example, notes added to particular product may automatically generate an email to any email addresses associated with that particular product. In addition, the system 200 allows for pushing of product from a remote location. That is, a particular vendor may move inventory from one location to another based on the inventory data 230. As inventory product 222 reaches certain levels, the vendor may be able to create, submit, or issue shipment orders through the interface system 228. In an example, the vendor may see the inventory levels at retail locations are low and proactively submit and issue a shipment order to route inventory product 222 from a distribution center to any retail location. The shipment order may outline the SKUs and individual EPC codes that are to be shipped and may automatically print shipping labels, bill of lading, or other shipping information at the particular distribution center. A user at the distribution center would then scan all inventory products 222 to be shipped and attach shipping labels or a bill of lading to the inventory product 222. The scans would upload the individual EPC codes to the system controller 208 and other users of the system 200 may then verify whether the correct inventory product 222 was scanned and either put a hold on shipping or send a confirmation to ship the inventory product 222. The system 200 may also allow shipping partners to be a user of the system 200. The shipping partner may then scan the inventory product 222 upon receipt of the inventory product 222 and then transport the inventory product. The inventory product 222 may then be scanned at whatever particular retail location receives the inventory product 222. At this point, the system 200 may automatically verify that the inventory product 222 received at the particular retail location matches the inventory product 222 scanned at the distribution center. All the scanning information can be checked and verified against one another to verify that the correct inventory product 222 is received. With the range of RFID signals, this may prove an advantage for users, as product may be shipped in large crates or other types of shipping containers. A user at a receiving facility may not have to open the shipping container to scan and receive the RFID signals from each individual inventory product 222. A user may utilize a mobile phone with RFID scanning capability to scan the entire shipping container and instantly know based on the individual RFID signals all inventory product 222 within the shipping container without the need of opening the shipping container. Without the need to open each shipping container or box, a user can simply utilize a mobile phone to effectuate a scan and collect inventory information quickly, easily, wirelessly, and accurately. Such efficiency allows for rapid up to date information to be kept of inventory data 230.

Inventory data 230 may include a centralized inventory library list, allowing for separate inventory lists for each location, and may include other individualized information regarding inventory product 222. The system allows for any type of information that users wish to track as a user may add particular information to the EPC codes that best suit their objectives.

All examples and embodiments allow for the tracking and management of any physical assets 202. While many of the examples and embodiments described herein refer specifically to merchandising product or inventory product 222, the examples and embodiments may include any other physical assets 202 tagged with RFID tags 204 including any non-merchandising assets 224. It is also noted that while RFID tags 204 are utilized in the examples and embodiments described herein, other similar technology utilizing near field communication, QR codes and notification, or other technology may be used to effectuate the process and steps described herein. Additionally, the system controller 208 may include modules 234 to interface between the inventory data 230 and the interface system 228.

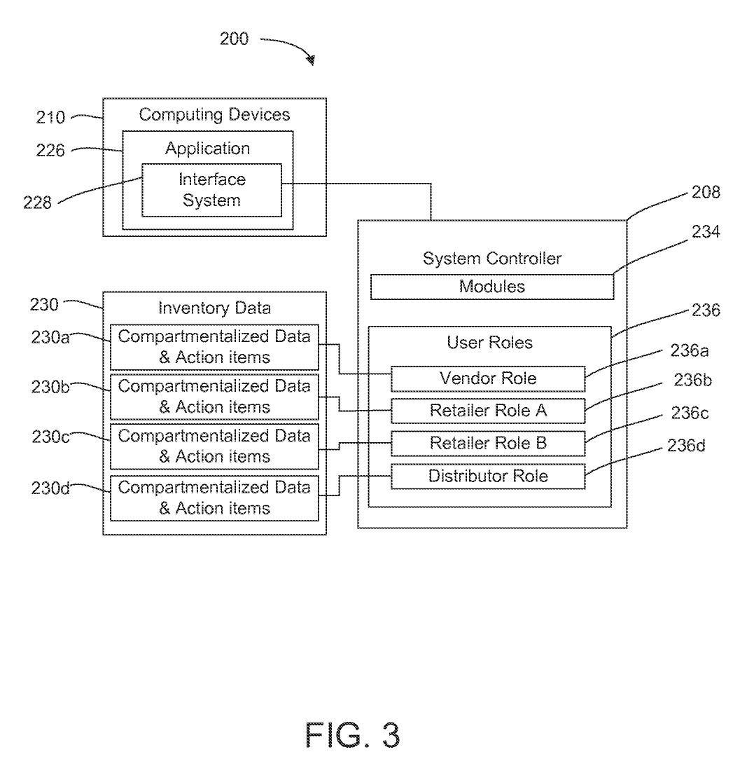

FIG. 3 depicts a schematic diagram of an embodiment of inventory management system 200 and for allowing unique roles of users granting access to individualized data and action items. Although the inventory management system 200 is shown and described with certain components and functionality, other embodiments of the inventory management system 200 may include fewer or more components to implement less or more functionality.

The illustrated embodiment depicts the interaction between the interface system 228, the system controller 208 and the inventory data 230, and illustrates the use of unique roles 236 to compartmentalize access to the inventory data 230 and what actions may be taken by certain roles 236. As the system 200 allows for many action to occur at different locations (including scanning, routing, shipping, receiving, sales, etc.), every user may not have an ability to accomplish certain tasks. Roles 236 may be divided in whatever manner suits particular users. For example, roles 236 may be divided based on organization, employee level, location, or any other distinguishing characteristic between individual users. In some embodiments, users may be required to login at computing devices 210 with a unique username and password. This allows for the tracking of which user executed any action or update to the inventory data 230.

In the illustrated embodiment, roles 236 include a vendor role 236a, a retailer role A 236b, a retailer role B 236c, and a distributor role 236d. The system allows for the creation of as many roles as may be required for a particular client. In the illustrated embodiment, the vendor role 236a may be granted access to compartmentalized data and action items 230a. The vendor role 236a may include various levels of access to the system. For example, a vender role 236a may allow for access only at a show level (granting access to a particular show or store), or at a distributor level (granting access to multiple shows or multiple stores). Additionally, the retailer role A 236b may be granted access to compartmentalized data and action items 230b, the retailer role B 236c may be granted access to compartmentalized data and action items 230c, and the distributor role 236d may be granted access to compartmentalized data and action items 230d. Each compartmentalized data 230a-230d may be particular to what the role 236a-236d requires. For example, users located at a certain location may be granted access to only inventory data 230 particular to that location. In some embodiments, only certain roles 236 may initiate scans of inventory product 222. In some embodiments, only certain roles 236 may route inventory product 222 from one location to another. In some embodiments, only certain roles 236 may create par thresholds or threshold levels of inventory. For example, a vendor may set a template or threshold level at a certain retail location, whereupon if the inventory level at that site falls below the template, a suggested order of inventory product 222 is automatically generated from a desired location to that certain retail location.

The use of roles 236 allows for the system 200 to function in any supply chain regardless of the roles that parties may enjoy. This allows for the system 200 to be programmed for use in traditional supply chains, or in consignment sales situations, in the use of showrooms or display rooms, or any other multi-party situation in bringing a product to market.

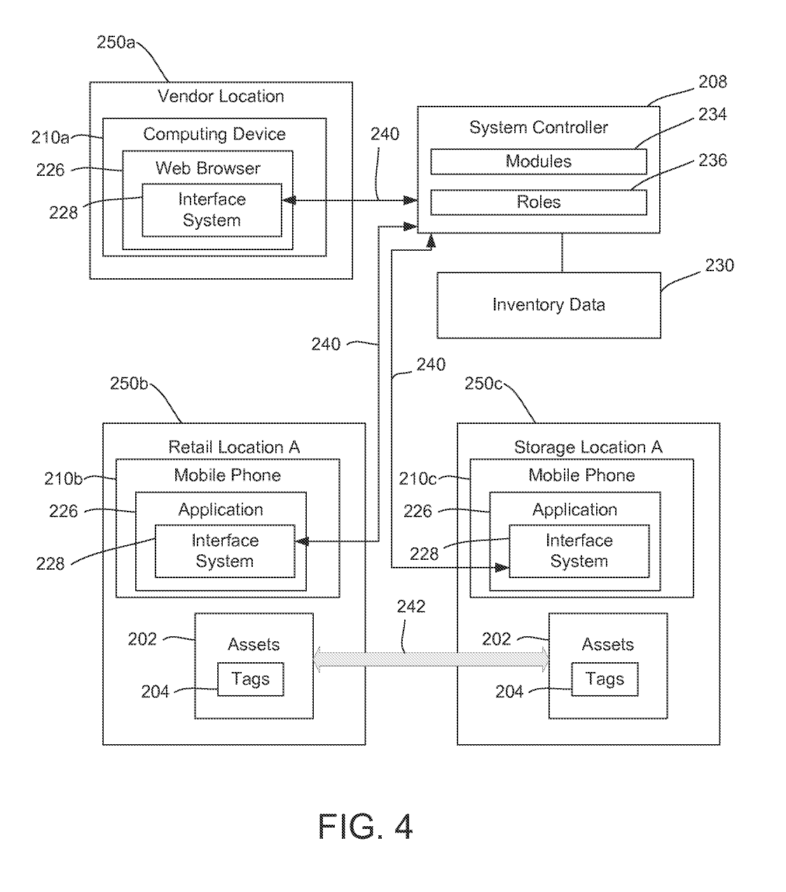

FIG. 4 depicts a schematic diagram of an embodiment of an inventory management system 200 implemented at various locations 250a-250c. Although the inventory management system 200 is shown and described with certain components and functionality, other embodiments of the inventory management system 200 may include fewer or more components to implement less or more functionality.

The illustrated embodiment includes users at three locations, a vendor location 250a, a retail location A 250b, and a storage location A 250c which may be a storage, warehouse, or distribution center which stores assets 202 for shipping to retail locations upon need. Each location 250a-250c may include a computing device(s) 210 including a system interface 228. Communication 240 occurs between each computing devices 210 and the system controller 208 by way of the interface system 228. The communication 240 may occur in many ways known, including wirelessly or wire communication, internet communication, or any other know communication method. Such communication 240 allows for the efficient management of assets at multiple locations. In some embodiments, the system 200 allows for a vendor at an off-site location 250a, through the interface system 228 to effectively route 242 assets 202 between locations 250b-250c. The vendor may communicate information through the interface system to route 242 assets 202 from a storage location A 250c to a particular retail location A 250b. As each asset 202 is tagged with an individual RFID tag 204, the vendor can route specific assets 202 to any location created in the system. The system 200 allows for the creation of new locations and/or temporary locations, that once created may allow a user to route assets to the new or temporary location and allows mobile users to access this location.

In some embodiments, when assets 202 are sold at the retail location A 250b, an inventory list stored in the inventory data 230 decrements the assets 202 sold from the inventory list. In some embodiments, a user scans the asset 202 sold, receiving the RFID signal from the RFID tag 204 on the asset 202. The information regarding the asset 202 is sent to the system controller 208 indicating that the asset 202 has been sold and the system controller 208 automatically decrements the asset 202 from the inventory list. Users may route and adjust non-merchandising assets 202 as well as merchandising assets 202 sold. Mobile users may adjust non-inventory assets when shipping to ensure the shipping piece count matches the shipping paperwork.

The system controller 208 may include various modules 234 utilized for managing and monitoring an inventory of product. Although the illustrated embodiment is shown and described with certain modules and functionality, other embodiments may include fewer or more modules to implement less or more functionality.

A user input module 234 may allow a user to enter information into the system. For example, information regarding a particular RFID tag 204 may be entered, thus creating a unique identifier for each particular RFID tag 204. A unique identifier may include information such as weight, permanent or limited use designation, product SKU, etc. The information may be stored on a database or other data structure. The database may be stored on the memory 212 or may be stored on a network of memory elements. Access to the database may be compartmentalized; allowing only authorized users access to certain information. Such fragmenting of access may be governed through logged in users and matching the access granted with the role of the user.

A location management module 234 may allow a user to manage inventory at one or more locations or in transit. In particular, a location management module 234 may allow a user to manage delivery to and transit from a location or multiple locations. This may allow a user to manage show rooms at various locations and eliminate any gaps in inventory at (or between) such locations. A location search module 234 may allow a user to view the start and stop dates of different shows at various locations, as well as other relevant information regarding the locations, and determine the number of transit days available between shows and locations. The location search module 234 may allow a user to determine openings and where best to implement displays of their merchandising product. A summary module 234 may provide information about the inventory that was sold and/or remains at a specific location. A distribution center management module 234 may be used to track the total inventory at a warehouse location and provide ability to input totals. The distribution center management module 234 allows for a user to manage a distribution center from a remote location and make decisions on whether to replenish inventory or ship inventory to another location. A module for creating a bill of lading 234 may allow a user to create a bill of lading for particular product. A user, such as a consignee or shipper, may scan a QR code on the bill of lading to quickly access the corresponding shipment. The bill of lading module 234 may automatically generate shipping documents such as a bill of lading, skid labels, and/or billing details. Shipping documents may be automatically emailed to the shipping location or receiving location via both a web and/or mobile user that manages shipping or receiving at a certain location. The modules 234 may include further functions that are within the skill level of those skilled in the art.

Some embodiments include the ability verify orders and scan accuracy. Users may place orders through the system 200 to pull or push inventory product 222 or assets 202 to/from certain locations. Users may create orders, save them, and indicate particular instructions with regard to the orders. In some embodiments, the accuracy of any shipments may be verified. Assets 202 may be scanned at the originating location as well as the receiving location, allowing for individualized comparison of the assets 202 scanned at both locations. Instantly, a user may be informed of any discrepancy between the two scans and decide on a course of action to remedy any problems. The simplicity through which scans occur allow for the scanning of a large number of assets 202 in a short amount of time without individually isolating each asset 202. An aggregate number of assets 202 may be tabulated to compare with a scan conducted at the originating location. The visibility of inventory data 230 allows for many metrics that may aid members of the supply chain to make decisions regarding inventory levels. Such visibility allows for determining shrinkage regardless of the origin of the reduction of inventory. Such reduction may occur through fraud, errors, or other methods. Regardless, the visibility of inventory on a level of individual items of a product allows for the tracking of each individual asset. If the system 200 is integrated along all points of a supply chain and the RFID tags are attached at manufacture, users are able to pinpoint when and where product is sold, stored, lost, or otherwise disposed of, allowing users to trace the entire “life” of the product.

The proliferation of smart phones with RFID scanning capability allows for any user of the system 200 to be created. By downloading an app 226, any user with a capable smart phone can effectuate processes within the system 200 for managing assets 202. For example, a user downloads the app 226, and creates a user through the system interface 228. The user may create a role 236 within the system which will grant access to certain data within the inventory data 230 and will grant access to creating various action items including routing of assets, scanning of assets, updating to inventory lists, create locations, create vendors, create retailers, create and assign roles, create templates and thresholds, create orders, create asset designations, create shipment orders, create bills of lading, and other actions described herein.

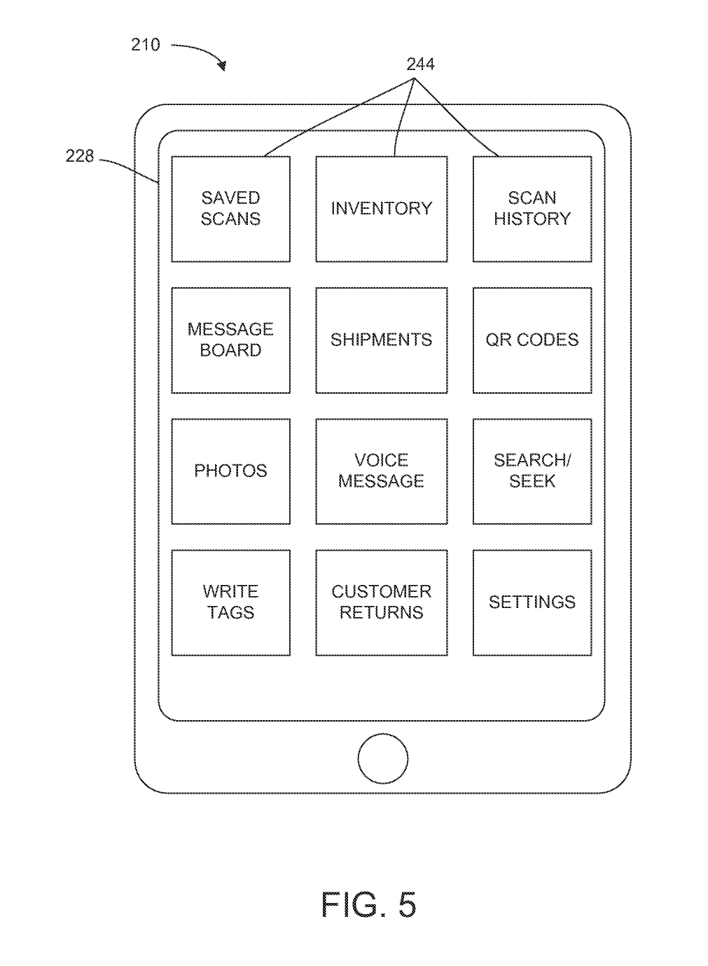

FIGS. 5-9 depict embodiments of a smart phone or computing device 210 with a system interface 228 for implementing and manipulating the modules 234 of the system controller 208. FIG. 5 depicts a mobile phone 210 showing the system interface 228. The system interface 228 depicts various icons 244 that may be accessed and allow for inputting information and manipulating modules 234. The icons shown are Saved Scans, Inventory, Scan History, Message Board, Shipments, QR Codes, Photos, Voice Message, Search/Seek, Write Tags, Customer Returns, and Settings. The Saved Scans icon may allow a user to access saved scans completed on the mobile phone 210. These saved scans may have not yet been uploaded to the system controller 208 and may be present only on the mobile phone 210. Users may also merge “like” scans. The Inventory icon may allow a user to view inventory at a certain location and may allow a user to initiate a scan session. The Scan History icon may allow a user to review and access the history of scans uploaded and parse information. Scan history information may be automatically uploaded to the system controller 208 and ordered to allow for analyzing by a user.

The Message Board icon may allow for various users (such as web administrators and others) to communicate with each other and post to a message board any issues or problems they may be facing. Web administrators or others may communicate with a mobile user regarding a shipment which must be verified by the mobile user, or a shipment which has delivered to the consignee. This allows mobile users located at a location to be automatically updated regarding shipments. The Shipments icon may allow a user to view and manage shipments either as a receiver or a sender. Confirmation and documentation may be determined through the module accessed through the Shipments icon. A user may also add pieces or subtract pieces from a shipment to ensure the shipping paperwork is consistent with the physical pieces shipping. The QR Code icon may allow a user to scan QR codes when a shipment is received, allowing the receiving party to access the corresponding shipment. This may allow for confirmation of whether the appropriate product was shipped correctly (e.g., does a virtual list align with the items physically scanned). The Photos icon may allow a user to take photos and attach such photos to various products, thereby allowing for a visual indication of the products at a point in time. The Voice Message icon may allow a user to leave a voice message and attached it to particular product or particular RFID tags or post to a particular location. The Search/Seek icon may allow a user to search for missing product by searching for particular RFID tags in order to locate particular product. The Customer Returns icon may allow a user to update the inventory when products are returned. The Settings icon may allow a user to manage settings of the various modules and system controller.

The Write Tags icon may allow a user to write or rewrite and input particular information and encode such information to a particular RFID tag. The information may be any unique identifier that uniquely identifies an RFID tag and distinguishes the particular product from other product in the inventory. The various icons described in conjunction with FIG. 5 are illustrative and not exhaustive, as skilled artisans may envision various modules and icons that may be implemented and allow users to manage inventory in an efficient manner, in light of the description provided herein.

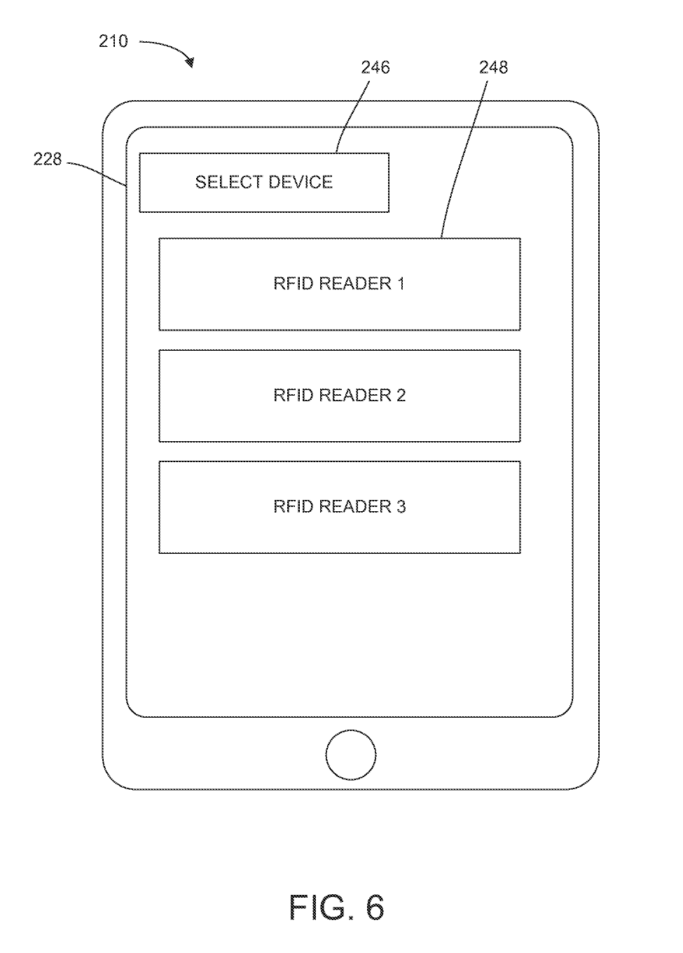

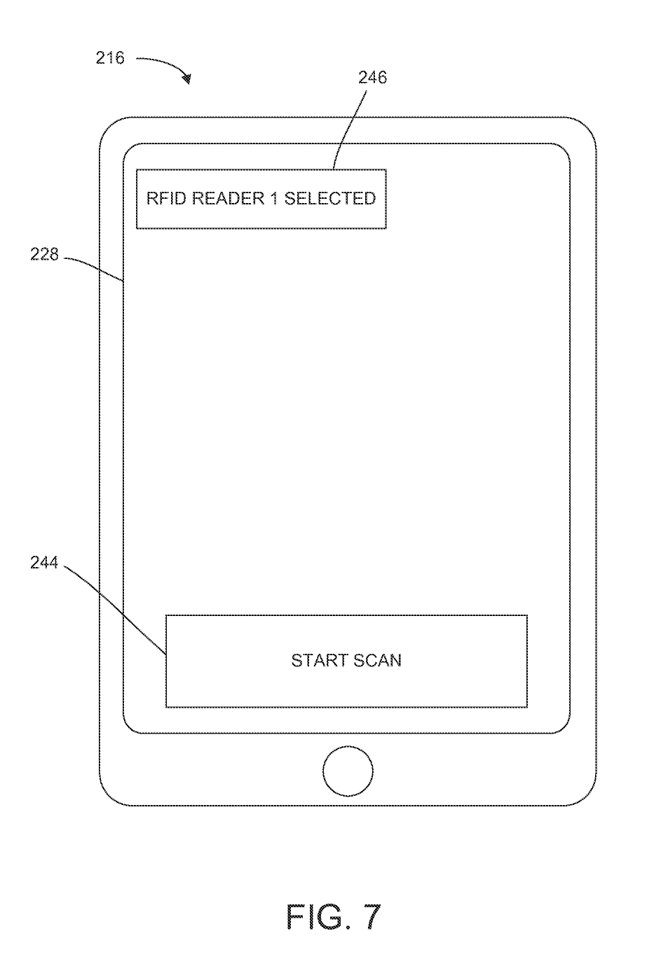

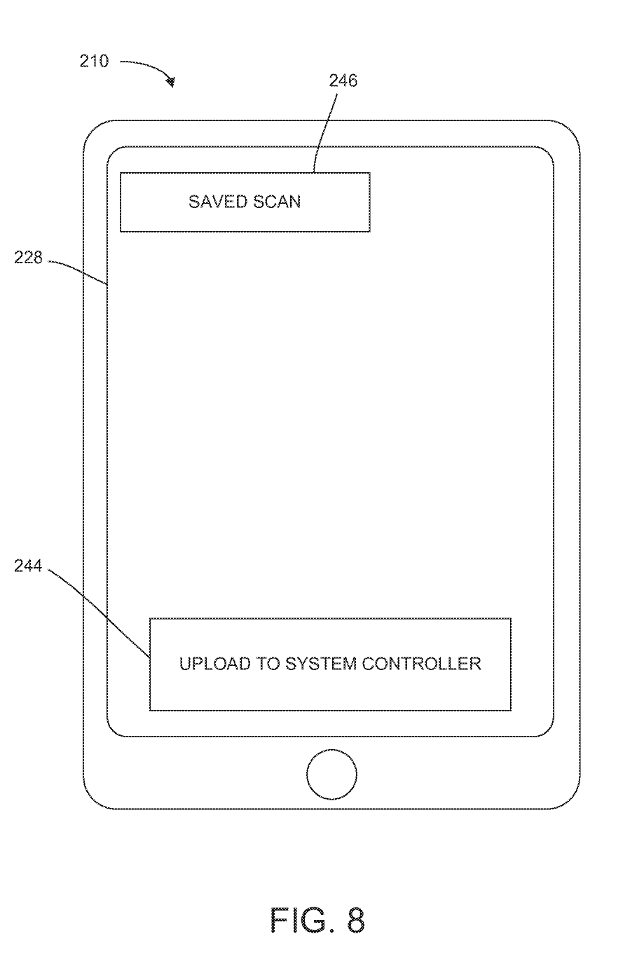

FIG. 6 depicts a mobile phone 210 with a system interface 228. On the system interface 228, a status identifier or prompt 246 may identify the status of a particular action. In the illustrated embodiment, the prompt 246 indicates that a user may select a particular RFID reader from a list of RFID readers. For example, a user may enter a storage location where inventory of product is located. The user may use a mobile phone 210 to log into the system and access the system controller 208. The software and/or modules may allow a user to search for nearby RFID readers to implement a scan. The mobile phone may indicate a list of RFID readers that may be connected to the user's mobile phone. For example, the list depicted shows RFID Reader 1, RFID Reader 2, and RFID Reader 3. The user then may select which RFID reader the user prefers to implement an action upon, such as a scan. FIG. 7 depicts the mobile phone 210 of FIG. 6 after an RFID reader is selected. The user may be presented with various options. In the illustrated embodiment, the user may select the icon 244 to start a scan, which will initiate a scan and send a command to the RFID reader to transmit a signal to the RFID tags and receive back a transmission from the RFID tags. From such a signal, the RFID reader may determine the presences of particular RFID tags in an area near the RFID reader. A user may then upload the scan to the system controller so all other users with access may view the scan results on a monitoring apparatus. FIG. 8 depicts the mobile phone 210 of FIG. 7 with an icon 244 that allows a user to upload information to the system controller.

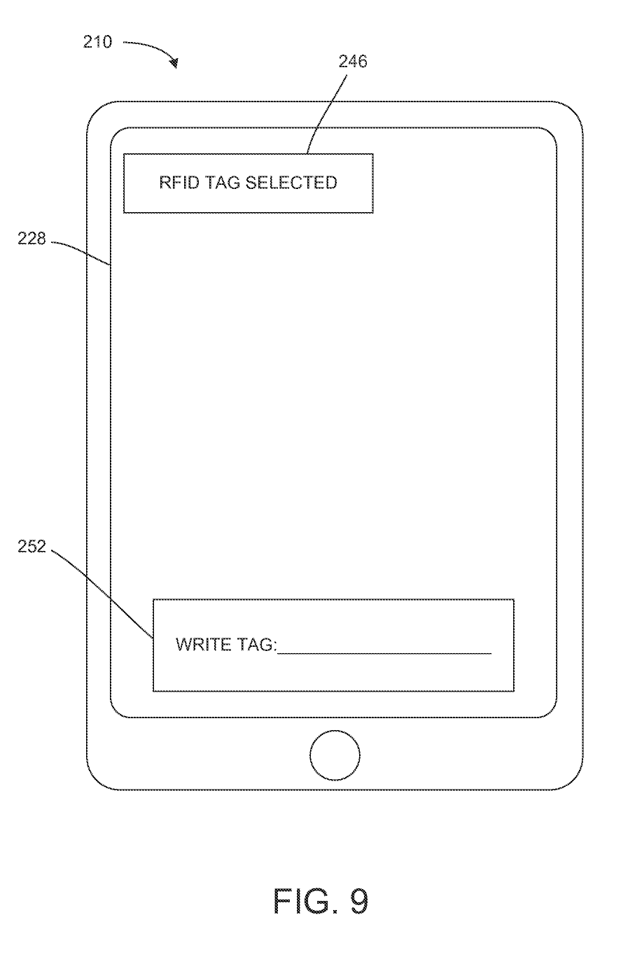

FIG. 9 depicts a mobile phone 210 displaying the system interface 228. On the user interface, a status identifier 246 indicates that a particular RFID scanner has been selected.

The system controller 208 and the modules 234 may be accessed on a computing device 210 through a website or an application 226. A user may access various modules and may take various actions. Illustrative actions are described below. The application and system controller may require authentication (or a login) in order to implement actions, connect, and access inventory information. Users may be prompted to create a username and password after which the user may be enabled for a specific role. Each role allows each unique user role mobile access. Roles that may grant varying access and capabilities may include a scheduler, merchandizing manager, receiving manager, database manager, directory manager, event manager, logistics manager, inventory manager, field rep, distribution center manager, shipping manager, and returns manager. Each user or group of users may be presented with a different dashboard view of information that is pertinent to their role. For example, the shipping manager may have an ability to view all shows/shipments carrier information in real time including costs, transit times, pickup numbers, tracking numbers and may have an ability to enter new carriers. An inventory manager may have an ability to see inventory levels at all distribution centers, shows, and in transit at all times. An administrator may create new users and assign roles and/or may create custom roles allowing unique access to certain systems.

It will be appreciated that the not all of the software modules described herein must be present to practice the present invention. For example, one, two, three or more of the modules may only be selectively utilized according to principles of the present invention.

While the foregoing embodiments utilized RFID technology, those skilled in the art may readily recognize the ability to utilize other near field communication technology in implementing some or all of the above functions that were described above in conjunction with the RFID tags, antennas, and RFID readers.

There is thus disclosed an improved multi-party mobile RFID inventory management system, and method of using the same.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, as described herein. The computer usable storage medium may be non-transitory.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A multi-party asset management system for managing mobile inventory, the system comprising:
a storage device configured to store a centralized inventory list of a plurality of assets, the plurality of assets located in more than one storage or retail location, wherein the assets comprise physical merchandising product, wherein an RFID tag is attached to each of the plurality of assets, wherein each RFID tag communicates a unique identifier;
a system controller that manages the inventory list, wherein the system controller is accessible to a unique user at each of the more than one storage or retail location through a web-accessible interface system, the interface system configured to manage the centralized inventory list and the plurality of assets, wherein the system controller defines roles for each unique user of the interface system, wherein each role grants unique access to information in the centralized inventory list and unique tasks to perform actions on the inventory list and the plurality of assets, wherein the roles comprise a vendor role and a retailer role;
wherein one of the actions comprises automatically decrementing an asset from the inventory list upon absence of an RFID tag associated with the asset during an RFID scanning of assets at the storage or retail location.

2. The asset management system of claim 1, wherein the system further comprises a mobile phone, wherein the RFID scanning is implemented on the mobile phone, wherein the mobile phone communicates to the system controller to count scanned RFID tags and decrement the asset associated with the absent RFID tag from the inventory list.

3. The asset management system of claim 1, wherein the vendor role is configured to perform actions, wherein one of the actions comprises routing assets from a first location to a second location, and wherein the system further includes a verification, wherein the verification matches a listing of the routed assets against physically scanned assets at the second location.

4. The asset management system of claim 1, wherein the more than one storage or retail location comprises a distribution center and more than one retail location, wherein the vendor role is configured to perform actions, wherein one of the actions comprises routing assets from the distribution center to more than one retail location.

5. The asset management system of claim 1, wherein the plurality of assets comprise assets from more than one vendor, and wherein a separate RFID tag is attached to each asset in the plurality of assets.

6. The asset management system of claim 1, wherein one of the actions comprises creating a temporary sales location, and wherein one of the actions further comprises routing assets to the temporary sales location in response to a secondary user authentication.

7. The asset management system of claim 1, wherein the system further comprises a mobile phone, wherein the mobile phone comprises an RFID reader to read the RFID tags at a location, and wherein the mobile phone comprises an application, wherein the application communicates with the system controller to manage the inventory list and the plurality of assets.

8. The asset management system of claim 1, wherein the plurality of assets comprise merchandising product and non-merchandising product, wherein an RFID tag is attached to each non-merchandising product.

9. The asset management system of claim 1, the system further comprising an RFID reader, wherein the RFID reader updates the inventory list of radio frequency signals indicating the presence of each RFID tag within a detection area surrounding the RFID scanner.

10. The asset management system of claim 1, wherein the inventory list comprises separate lists of assets separated in each location of the more than one retail location, wherein the separate lists comprise a par threshold, wherein a shipment of assets is automatically scheduled in response to an inventory level dropping below the par threshold on one of the separate lists.

11. A computer program product comprising:
a computer useable storage medium including a computer readable program, wherein the computer readable program includes instructions that, when executed by a processing device within a computer, cause the computer to perform operations comprising:
storing an inventory list of a plurality of assets, the plurality of assets located in more than one storage or retail location, wherein the assets comprise merchandising product, an RFID tag attached to each of the plurality of assets, wherein each RFID tag communicates a unique identifier;
receiving a signal indicating the scanning of an RFID tag by a user, the RFID tag associated with one asset of the plurality of assets, wherein the signal is transmitted through a web-accessible interface system coupled to a computing device, the interface system configured to manage the inventory list and the plurality of assets through a system controller, wherein the system controller defines roles for each unique user of the interface system, wherein each role grants unique access to information in the centralized inventory list and unique tasks to perform actions on the inventory list and the plurality of assets;
decrementing the asset from the inventory list in response to receiving a signal indicating an absence of the RFID tag on a subsequent RFID scan of the plurality of assets.

12. The computer program product of claim 11, wherein the computer program product, when executed by a processing device within the computer, causes the computer to perform additional operations comprising:
receiving an input command to route assets of the plurality of assets from a first location of the more than one storage or retail location to a second location of the more than one storage or retail location;
communicating a shipment order to a user of the web-accessible interface system located at the first location, wherein the shipment order comprises each unique identifier associated with RFID tags as indicated in the input command.

13. The computer program product of claim 11, wherein the inventory list comprises separate lists of assets separated in each location of the more than one storage or retail location, and wherein the computer program product, when executed by a processing device within the computer, causes the computer to perform additional operations comprising:
creating a temporary retail location in the inventory list in response to an input command by a user;
receiving an input command to route assets of the plurality of assets from a first location of the more than one storage or retail location to the temporary retail location;
communicating a shipment order to a user of the web-accessible interface system located at the first location.

14. The computer program product of claim 13, wherein the computer program product, when executed by a processing device within the computer, causes the computer to perform additional operations comprising:
creating a shipment order of assets in response to an inventory level at a location being below a par threshold comprising a threshold level of inventory at the location.

15. The computer program product of claim 11, wherein the computer program product, when executed by a processing device within the computer, causes the computer to perform additional operations comprising:
receiving a first scan information from an originating shipping location and second scan information from a receiving location; and
comparing the first and second scan information.

16. A computer implemented method, the method comprising:
storing an inventory list of a plurality of assets, the plurality of assets located in more than one storage or retail location, wherein the assets comprise merchandising product, an RFID tag attached to each of the plurality of assets, wherein each RFID tag communicates a unique identifier;
receiving a signal indicating the scanning of an RFID tag by a user, the RFID tag associated with one asset of the plurality of assets, wherein the signal is transmitted through a web-accessible interface system coupled to a computing device, the interface system configured to manage the inventory list and the plurality of assets through a system controller, wherein the system controller defines roles for each unique user of the interface system, wherein each role grants unique access to information in the centralized inventory list and unique tasks to perform actions on the inventory list and the plurality of assets;
decrementing the asset from the inventory list in response to receiving a signal indicating an absence of the RFID tag on a subsequent RFID scan of the plurality of assets.

17. The method of claim 16, the method further comprising:
receiving an input command to route assets of the plurality of assets from a first location of the more than one storage or retail location to a second location of the more than one storage or retail location;
communicating a shipment order to a user of the web-accessible interface system located at the first location, wherein the shipment order comprises each unique identifier associated with RFID tags as indicated in the input command.

18. The method of claim 16, wherein the inventory list comprises lists of assets separated in each location of the more than one storage or retail location, and the method further comprising:
creating a retail location in the inventory list in response to an input command by a user;
receiving an input command to route assets of the plurality of assets from a first location of the more than one storage or retail location to the retail location;
communicating a shipment order to a user of the web-accessible interface system located at the first location.

19. The method of claim 18, the method further comprising:
creating a shipment order of assets in response to an inventory level at a location being below a par threshold comprising a threshold level of inventory at the location.

20. The method of claim 16, the method further comprising:
receiving a first scan information from an originating shipping location and second scan information from a receiving location; and
comparing the first and second scan information.
